(19) United States
(12) Patent Application Publication
(10) Pub. No.: US 2023/0146140 A1
(43) Pub. Date: May 11, 2023

(54) HIGH VOLTAGE HIGH POWER MODULAR POWER SUPPLY

(71) Applicant: LEONARDO ROQUE, VALRICO, FL (US)

(72) Inventor: LEONARDO ROQUE, VALRICO, FL (US)

(21) Appl. No.: 17/865,448

(22) Filed: Jul. 15, 2022

Related U.S. Application Data
(60) Provisional application No. 63/222,409, filed on Jul. 15, 2021.

(51) Int. Cl. H02M 3/335; H02M 3/00; H02M 1/42

(52) U.S. Cl. CPC H02M 3/33571; H02M 1/42; H02M 3/01

(57) ABSTRACT

A high voltage power supply unit composed of modules in an open loop configuration and series connected to achieve stable high voltage and high power operation. The high voltage power supply produces 1600 VDC @ 0.8 Amps and is composed of 4-400 VDC / 300 watts modules fed by an AC mains in parallel, with their individual outputs connected in series to achieve the 1600 VDC. One advantage to this circuit arrangement of the power modules is that any voltage level, current level or desired power rating can be accomplished, whether in a constant voltage (CV) mode, or constant current (CC) mode or a combination of both. Advantages of the disclosed power unit and its individual modules is lack of instabilities, digital setting, good load regulation and excellent low temperature drift.

### CLAIM OF PRIORITY

This application claims the benefit of and priority to U.S. Provisional Application with serial number 63/222409, filed on Jul. 15, 2021, with the same title, the contents of which are hereby incorporated by reference in its entirety.

### FIELD AND BACKGROUND OF THE INVENTION

Presently, there is a gap in the medium power switching power supply world from 75 to <3000 VDC, including high voltage capacitor charging power supplies used in high energy flashlamps applications. Various factors account for this including: a) instability and oscillations when closing the loop due to the high open loop gain of the designs; b) lack of ease of trimming of output voltage; c) poor load regulation when using an open loop design; d) poor temperature stability; and e) the proper way to stack the modules in series at the output. Therefore, there is a need for a power supply that overcomes these disadvantages in prior art power supplies.

### SUMMARY OF THE INVENTION

The inventive concepts disclosed herein include embodiments primarily directed to high voltage power supply units for UVC (ultraviolet C) pulsed lamp applications but are not necessarily limited to such applications. In one example embodiment, a high voltage power supply produces about 1600 VDC @ 0.8 Amps Peak and is composed of 4-400 VDC / 300 watts modules fed by an AC mains in parallel, and their individual outputs connected in series to achieve the 1600 VDC. One advantage to this circuit arrangement of the power modules is that any voltage level, a current level or desired power rating can be accomplished with this inventive power supply, whether in a constant voltage (CV) mode or constant current (CC) mode.

Other advantages of the inventive power supply include the use of: a) open loop techniques in the design of the power modules; and b) the series connections of the power module outputs to achieve the higher desired voltages and proper isolation by using overdesigned transformers exhibiting low switching losses. By changing each individual high voltage power supply module or unit to a constant current (CC) power supply, it allows for the connection or coupling of more than one of these power supply units in parallel, thereby providing a two-tier connection. Hence, in one embodiment, more than one power supply module is connected at their outputs in series to achieve a high voltage power supply system. In a related embodiment, more than one high voltage module outputs are connected in parallel operation to achieve high voltage stability and higher current and power levels. Each of the composite power supply modules’ voltages are set digitally by their 12-bit DACs (digital to analog converter, such as a Texas Instruments DAC60501 device).

In one example embodiment, there is provided a high voltage power supply unit that includes a plurality of power modules with each set digitally to any voltage and each having an input and an output, the plurality of power modules designed to be electrically connected in parallel at their respective inputs and connected in series at their respective outputs, wherein each of the power modules includes a power factor correction (PFC) pre-regulator stage electrically coupled to a DC to DC converter stage coupled to a transformer that provides isolation. The novel power supply exhibiting an improved load regulation performance due to an over design of the transformer unit, keeping its core, copper and other switching losses to a minimum. In this example embodiment, the DC to DC converter includes a half bridge converter operating in an open loop configuration with its output voltage digitally settable. The power supply is not necessarily limited to the half bridge topology and can use a full bridge or a forward converter circuit.

In another example embodiment, there is provided a high voltage power supply including a plurality of power modules with each power module configured to be set digitally to any defined voltage with a digital to analog converter device, each of the power modules configured to be electrically connected in parallel at their respective inputs and connected in series with an anti-parallel device at the respective outputs of each power module to provide a stable and higher voltage output. In particular, each of the power modules is configured in an open loop design to include a power factor correction (PFC) pre-regulator stage electrically coupled to a DC to DC converter stage, an output of the DC to DC converter stage being electrically coupled to a transformer unit so as to improve load regulation performance and provide isolation.

In yet another example embodiment, there is provided a high voltage power supply capable of providing high current that includes a plurality of power modules with each power module configured to be set digitally to any defined voltage with a digital to analog converter device, each of the power modules configured to be electrically connected in parallel at their respective inputs and connected in parallel at the respective outputs of each power module to provide a higher current and higher power output, each power module converted to operate in a constant current (CC) mode. In particular, each of the power modules are configured in an open loop design to include a power factor correction (PFC) pre-regulator stage electrically coupled to a DC to DC converter stage, an output of the DC to DC converter stage being electrically coupled to a transformer unit so as to improve load regulation performance and provide isolation. In a related embodiment, each individual power supply module or unit is converted to a Constant current (CC) unit and its output connected in parallel to at least another CC power supply unit to provide for a high voltage / high current unit or system consisting of more than one high voltage power supply units.

### BRIEF DESCRIPTION OF THE DRAWINGS

Other objects and advantages of the invention will become apparent upon reading the following detailed description and upon reference to the accompanying drawings in which:

FIGS. 1 and 1A illustrate a block diagram or schematic of a high voltage power supply and a conversion circuit for converting a power module into constant current mode, respectively.

FIGS. 2 and 2A illustrate a block diagram of a 400 VDC / 300 watts power module used as a component of the disclosed high voltage power supply and a table illustrating the various operating parameters, respectively.

FIG. 3 illustrates a partial schematic of a DC to DC converter used in a high voltage power module.

FIG. 4A illustrates a graph of the Voltage Reference used Short Term Temperature Drift

FIG. 4B illustrates a graph of the Voltage Reference used Long Term Temperature Drift

FIG. 4C illustrates a graph of the ½ Bridge DC to DC Converter’s Temperature Drift

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF THE PREFERRED EMBODIMENTS

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

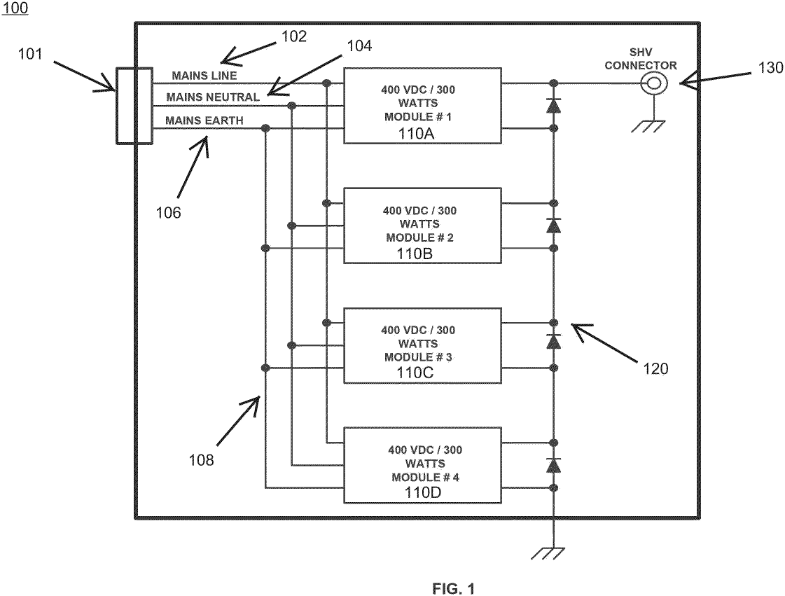

Referring now to the Figures, specifically FIGS. 1 and 1A, illustrate a block diagram or schematic of a high voltage power supply and a conversion circuit for converting a power module into constant current mode, respectively. In one example embodiment, a high voltage (HV) power supply 100 is designed to produce at least 1600 VDC at 0.75 Amps and it consists of four (4) (or more) modules 110A-110D with their Mains inputs 102 (line), 104 (neutral) and 106 (ground/earth), respectively, connected in parallel connections 108 and with their respective outputs 120 connected in series, where the connections and its value/size units are shown, all connected to an SHV connector 130 (in the form of a coaxial cable connector, in this embodiment). Although a number of examples described herein use the HV power supply in connection with UVC flashlamps, the power supply described herein is not necessarily limited to those applications only.

In this example embodiment, HV power supply 100 operates with an AC input of 90-265 VAC, at 50/60 Hz and has a power factor less an 99% and operates at an efficiency of about 90%. Cooling is provided with forced air, and has an operating temperature of 0-45° C. Operating mode for supply 100 is either RC or CC (constant current) using a resistor of 2J ohms and a capacitor of 500 microfarads. Charging time is about 4 seconds and the output is 1600 VDC +/-2%.

In this and other related embodiments, there are two modes of charging an energy storage capacitor used to discharge its energy into a flashlamp or in a flashlamp-type application. Hence, while in the constant current mode the high voltage power supply 100 will operate as or be converted into a constant current source to charge the capacitor linearly. While in the RC Mode, the high voltage power supply 100 will charge the capacitor exponentially through a series resistor. The following definitions and example are provided for context when using the inventive concept with flashlamps:
Complete Interval Time, where the two or three Flashlamp units have gone through a complete cycle = 4 seconds:
Charge Capacitor: 500 uF

For the CC Mode (constant current), the current required is Icc = VC/T

Icc = (1600 × 500 × 10⁻⁶) / 4 = 2 Amps

The power required from the Power Supply will be Pload = 1600 × 2 × ½ = 1600 watts.

For the RC Mode, the energy stored in the capacitor is E = ½ CV² = ½ × 500 × 10⁻⁶ × 1600² = 640 joules, requiring the following power from the power supply: Pload = 640/4 = 160 watts Additionally, the resistor value required is calculated as follows: 4 RC = 4 (To charge capacitor to 98% of peak voltage of 1600 VDC). Therefore: RC = 1 and R = 1/C = 1/(500 × 10⁻⁶) = 2 K ohms The RC Mode is chosen as it requires ⅒ the power from the power supply. A simple and very efficient circuit to convert a CV (constant voltage) power supply to a CC (constant current) power supply is shown in FIG. 1A. In particular, R1 is used to isolate the Op Amp from the large Cin of the IGBT. R2 and C form a filter to reduce interference while R3 sets the constant current through the IGBT and load capacitor = 2.5 VDC/2.5 ohms = 1 Amp.

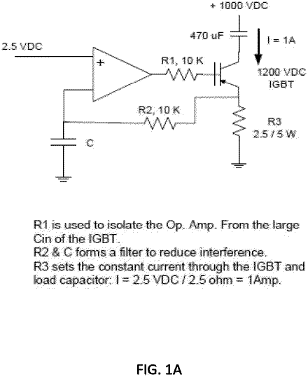

Referring now to FIG. 2-2A, illustrate a block diagram of a 400 VDC / 300 watts power module used as a component of the disclosed high voltage power supply and a table illustrating the various operating parameters, respectively. In particular, there is illustrated a 400 VDC/300 watt module, such as module 110A, in schematic form which includes, in this embodiment, a PFC (power factor correction) section or stage 112A electrically coupled to a DC to DC Converter section or stage 114A along with its performance parameters for these two (2) sections. In this example embodiment, PFC stage 112A uses the Mains Universal input 101 (90 to 265 VAC, 50/60 Hz.) and provides a stable line regulated output of 390 to 400 VDC at a current up to 0.8 Amps. This example embodiment exhibits a Power Factor Correction of > 0.99, efficiency of 95% and harmonic distortion of less than 10%. DC to DC Converter stage 114A uses an Open Loop design approach, where the 400 VDC from PFC stage 112A is isolated and converted into a 400 VDC or less (trimmable down to 100 VDC voltage) to produce an adjustable or fixed voltage source of more than 300 watts of power with good load regulation and very low temperature drift.

The following specifications in connection with the circuit illustrated in FIG. 2 include a PFC stage that uses the Boost Topology:

### Input

Mains Input 90 to 265 VAC, 47 o 63 Hz. With an Mains Input Current: 4 A@90 VAC
Inrush Current:< 30 Amps@110 VAC and a Power Factor:0.993 to 0.999 @ 110 VAC
AC Mains Harmonics: 3.3 to 8.6 % @ 110 VAC; operates at Efficiency: 94.8 to 95.6%@ 110 VAC

### Output

Output Voltage; 390 to 400 VDC with an Output Current: 0.8 A maximum
Line Regulation: 0.12% @ full load of 0.8 A and a Load Regulation: 0.27% from 0.1 to 0.8 A.
Output Ripple: < 5 Volts P-P

The DC to DC Converter stage uses the Half Bridge topology in an Open Loop Configuration, and has the following specifications:
Output Voltage: 400 V C ± 2% @ 0.75 A, with Output Voltage stability via the Duty Cycle
Load Regulation : < 3% from 0.1 to 0.75 A.
Extremely stable Voltage reference (very low Temperature drift)
Short and long thermal Drift Extremely stable using a 12 bit D/A to set the Duty cycle.
Efficiency; > 95% with an Output Ripple: < 1 VOLT P-P

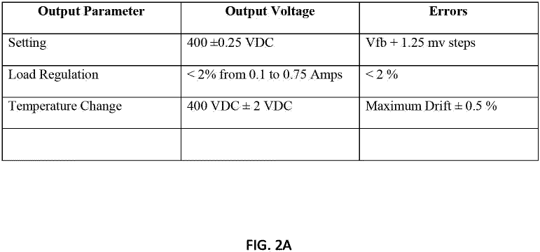

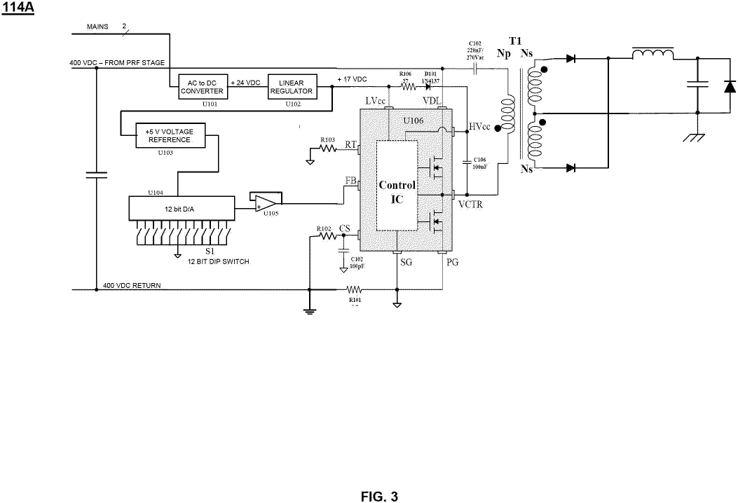

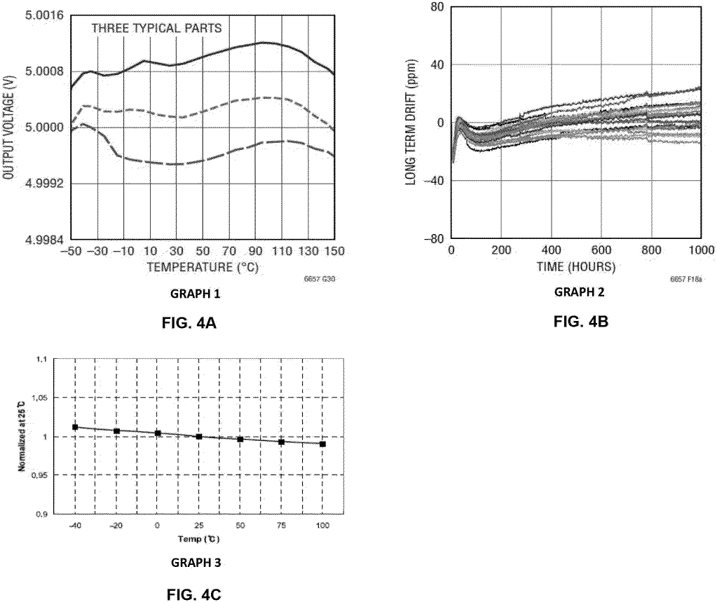

Reference is now made to FIGS. 2-2A and 4A-4C primarily and to the use of Open Loop techniques in the design of modules 110A-110D. FIG. 4A illustrates an Output Voltage Setting of a 12 bit DAC being used. In particular, FIGS. 4A-4C help to illustrate all of the sources of errors in the design of the DC to DC converter. In a normal switching power supply design, use of a closed loop design will minimize all of the errors and disadvantages described in relation to FIGS. 4A-4C, except when dealing with high open loop gains as is the case many times with high voltage power supplies, whereas closing the loop could and will produce instabilities and oscillations. However, in our example embodiments, the instabilities and oscillations are completely eliminated, thereby producing a stable and predictable output voltage and current.

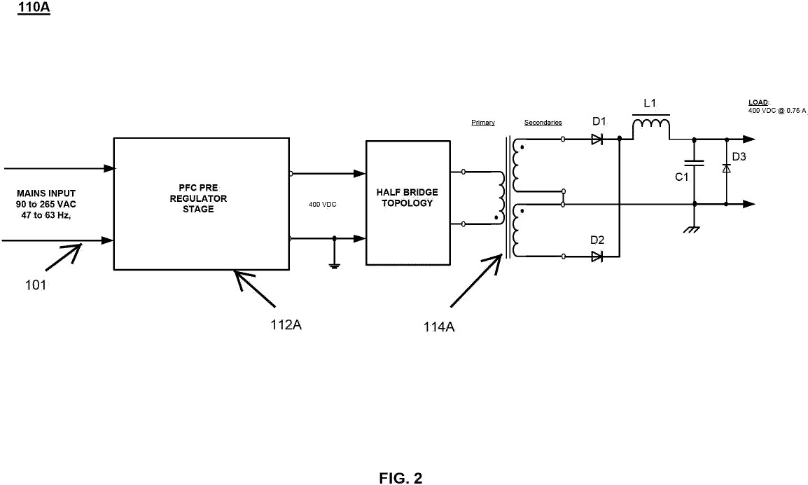

Referring to FIGS. 2, 2A and 3, individual power module 110A includes a PFC Pre-Regulator stage 112A electrically coupled to DC to DC Converter stage 114A which shows a load regulation of < 2%, shown in FIG. 2. FIG. 3 shows the Open Loop design of the DC to DC converter portion 114A of the power module 110A. The improved load regulation performance is accomplished by an over design of the transformer, keeping its core, copper and other switching losses to a minimum of 0.5% of its 400 watts ratings, which is equal to about 2 watts maximum. In particular, DC to DC converter 114A illustrates that the 400 VDC from PRF stage 112A feeds the high voltage section of the ½ bridge control/converter U106 while the low voltage circuitry (LVcc) is fed 17 VDC by a circuit including an AC to DC converter U101 and a linear regulator U102. The output of linear regulator U102 also feeds a very low noise, low drift +5 VDC reference U103 which provides a reference voltage of a 12 bit DAC U104. In turn, U104 drives an analog buffer U105, which in turn feeds the feedback (FB) input of the ½ bridge converter U106. In this example embodiment, transformer T1 had been overdesigned so that its losses (core, copper, parasitic) have been minimized (< than 0.5% of 300 watts).

The circuit of the 400 VDC/300 watt module of FIG. 3 uses the open Loop design of the DC to DC Converter stage of the module to achieve the needed performance of the overall module. The PRF stage provides the required performance like: Universal mains input. outstanding Power Factor Correction of > 0.99, Harmonic Distortion of < 10% at all Universal Input levels, outstanding Line Regulation. The 400 VDC from the PRF stage feeds the High Voltage section of the ½ Bridge Control/ Converter U106, while its Low Voltage circuitry (LVcc) is fed by a circuit composed of 3 AC to DC Converter U101 and Linear Regulator U102 that provides the required +17 VDC. The Output of U102 also feeds at a very Low Noise, Low Drift+ 5 VDC Voltage Reference U103 that provides the reference voltage to a 12 bit DAC (U104). U104 drives Analog Buffer U105; which in turn, feeds the Feedback (FB) input of the ½, Bridge Converter (U106) Transformer T1 has been overdesigned so that its losses (Core, Cooper, Parasitic) have been minimized (< than 0.5% of 300 watts).

Referring now to FIGS. 4A-4C and a discussion of the sources of errors, assuming temperature range of -10 to +70° C., with respect to Load Regulation: by overdesigning the Output Transformer to keep the Core Losses, Cooper Losses and the Parasitic losses to less than 1% total, a load regulation of 1.5 % from 0.05 to 0.75 Amps is met. Setability: The voltage that feeds the FB input of the controller has a resolution of 1.25 mv per step, more than adequate to achieve unit to unit performance. Unit to Unit Tracking: as shown in FIG. 4A (Graph# 1) the component (unit variation) is around 0.8 mv. Short Term Temperature Drift: As shown on FIG. 4A while Long Term Temperature Drift is shown in FIG. 4B. Internal drift of the ½ Bridge is DC to DC Converter as shown in FIG. 4C. With reference to the 12 bit D/A device resolution - 4096 steps full scale (0 to 5 VDC). 1-3 VDC input range of ½ bridge controller is the delta change of 2 VDC = 40% of full range. Therefore, final resolution = 4096 × 0.04 = 1600 steps or 200 mvolts / 1600 = 1.25 mvolt per step.

In reference to Total Temperature Drift, we refer now to FIG. 4A (Graph 1) and Voltage Reference Short Term Drift. In this graph there is shown 3 samples with a maximum error of 0.4 mv from -10 to +70° C. Referring to FIG. 4B (Graph 2) - Voltage Reference Long Term Drift, there is shown 10 samples, each with a maximum error of < 20 ppm (20 parts per million) for a maximum error of: e = (5 × 20) /10⁶ - 0.1 mv. Referring to FIG. 4C, DC to DC Converter Temperature Drift is shown to have a substantially linear relationship, with a maximum error from 0 to +70° C. estimated at 0.005 of nominal value 2 volts = 10 mv. This represents a 0.005 change in pulse width that translates roughly to a 0.005 change of output voltage. Hence, the total drift is: (0.4² + 0.1² + 10²)^{½} = 10.008 mv or 0.5% of Output Voltage. For a value of 400 ± 2 volts over the Temperature Range of 0 to +70° C.

The table illustrated as FIG. 2A illustrates various parameters related to module 110A (for example) output vs. setting, load regulation and temperature performance.

As illustrated in FIG. 1, the series connections of the power modules 110A-110D at the outputs 120 achieve the desired higher voltages. In related embodiments, any 2 or more power supplies can be connected in series, independent of their respective output voltages. However, some issues need to be addressed and will lead to better outcomes by implementing one or more of the following: 1) use of identical sized units, possibly supplied from the same source/manufacturer; 2) be observant as to the load needed current in order to not overload any of the power supply system’s individual modules or units; and 3) be aware that individual power modules or units may have different start-up times. In order to avoid reverse voltage on the power supply module outputs due to the earlier start of some of the individual power modules in the power supply system an anti-parallel diode or device (rated to the maximum voltage of the system and with a peak surge current at least equal to the nominal current) should be connected to each power module output.

Referring again to FIG. 1, all of the 4 power modules 110A-110D inputs are connected in parallel 108, while their outputs 120 are connected in series along with the implementation of anti-parallel diodes 111A-111D (or any other non-linear semiconductor device) to eliminate different start-up times problems. In one example embodiment, high voltage power supply 100 is encased in an enclosure housing all 4 of modules 110A-110D (PCBs) and using forced air cooling in the form of 2 - 3” square fans, power supply 100 high voltage output will be 1600 VDC +/- 2% through an SHV connector 130 rated at 5 KV. This embodiment uses a 2 K ohm resistor and a 500 microfarad capacitor with a charging time of 4 seconds.

In related embodiments and depending on the application, more or less individual power modules have their inputs connected in parallel with the respective outputs being connected in series or in parallel depending on the needs for charging the storage capacitor, such as linear or exponential charging.

The following patents are incorporated by reference in their entireties: U.S. Pat. Nos. 8,816,301; 9,517,284; and 10,874,760.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A high voltage power supply comprising:
a plurality of power modules with each power module adapted to be set digitally to any defined voltage with a digital to analog converter device, each of the power modules adapted to be electrically connected in parallel at their respective inputs and connected in series with an anti-parallel device at the respective outputs of each power module to provide a stable and higher voltage output; and
wherein each of the power modules is configured in an open loop design to include a power factor correction (PFC) pre-regulator stage electrically coupled to a DC to DC converter stage, an output of the DC to DC converter stage being electrically coupled to a transformer unit so as to improve load regulation performance and provide isolation.

2. The high voltage power supply of claim 1 wherein the DC to DC converter includes a half bridge converter circuit or topology operating in the open loop configuration with an output voltage of the DC to DC converter being digitally settable.

3. The high power supply of claim 1 wherein the DC to DC converter includes a full bridge converter circuit.

4. The high voltage power supply of claim 1 adapted to power a germicidal flashlamp system including a plurality of flashlamps that are individually pulsed, wherein up to four (4) 400 VDC power modules are provided having their respective outputs connected in series to produce 1600 VDC at 0.8 Amperes.

5. The high voltage power supply of claim 4 wherein the switching losses are at 0.5% of the transformer 400 watts ratings.

6. The high voltage power supply of claim 1 wherein the transformer is configured to reduce switching losses in a core and in a copper winding of the transformer.

7. The high voltage power supply of claim 1 wherein the power supply is configured to operate in an RC Mode thereby charging an energy storage capacitor exponentially through a series resistor.

8. The high voltage power supply of claim 1 wherein the DC to DC converter includes a forward converter circuit.

9. The high voltage power supply of claim 1 wherein any 2 or more power modules are adapted to be connected in series, independent of their respective output voltages.

10. A high voltage power supply capable of providing high current comprising:
a plurality of power modules with each power module adapted to be set digitally to any defined voltage with a digital to analog converter device, each of the power modules adapted to be electrically connected in parallel at their respective inputs and connected in parallel at the respective outputs of each power module to provide a higher current and higher power output, each power module converted to operate in a constant current (CC) mode; and
wherein each of the power modules are configured in an open loop design to include a power factor correction (PFC) pre-regulator stage electrically coupled to a DC to DC converter stage, an output of the DC to DC converter stage being electrically coupled to a transformer unit so as to improve load regulation performance and provide isolation.

11. The high voltage power supply of claim 10 wherein the power supply is adapted to charge an energy storage capacitor linearly.

12. The high voltage power supply of claim 10 wherein the DC to DC converter includes a half bridge converter circuit or topology operating in the open loop configuration with an output voltage of the DC to DC converter being digitally settable.

13. The high voltage power supply of claim 10 wherein the DC to DC converter includes a full bridge converter circuit.

14. The high voltage power supply of claim 10 wherein the transformer is configured to reduce switching losses in a core and in a copper winding of the transformer.

15. The high voltage power supply of claim 10 wherein the DC to DC converter includes a forward converter circuit.
